(19) United States
(12) Patent Application Publication
(10) Pub. No.: US 2004/0059840 A1
(43) Pub. Date: Mar. 25, 2004

(54) Method and apparatus for the dynamic scheduling of device commands

(76) Inventors: Richard E. Perego, San Jose, CA (US); Frederick A. Ware, Los Altos Hills, CA (US); Craig E. Hampel, San Jose, CA (US); Ely K. Tsern, Los Altos, CA (US)

Correspondence Address: ROSS D. SNYDER & ASSOCIATES, INC., 115 WILD BASIN RD., SUITE 107, AUSTIN, TX, 78746, US

(21) Appl. No.: 10/601,023

(22) Filed: Jun. 20, 2003

Related U.S. Application Data
(63) Continuation-in-part of application No. 10/268,808, filed on Oct. 9, 2002.
(60) Provisional application No. 60/390,273, filed on Jun. 20, 2002.

(51) Int. Cl. G06F 3/00

(52) U.S. Cl. 710/6

(57) ABSTRACT

Methods and apparatuses for scheduling commands are described. According to various embodiments of the invention delay information, which is associated with a command is issued. The delay information directs the device for which the command is intended to either execute the command immediately or to delay the command for some period of time before execution. Multiple commands can be queued for execution within the device.

### CO-PENDING APPLICATION

This application is a continuation-in-part of U.S. patent application Ser. No. 10/268,808, filed on Oct. 9, 2002, and entitled “ZERO OVERHEAD REFRESH IN A DRAM MEMORY SYSTEM.” This application hereby claims benefit under 35 U.S.C. 119(e) of U.S. provisional patent application 60/390,273, filed on Jun. 20, 2002, entitled “METHOD AND APPARATUS FOR SCHEDULING DEVICE COMMANDS.”

### FIELD OF THE DISCLOSURE

The invention relates generally to scheduling of device commands to be performed by a device.

### BACKGROUND

Many systems involve devices that process commands over time. Such devices are typically limited in the amount of information that they can process at any given time. Also, such devices often send and/or receive information over communication paths that are limited in the amount of information that they can communicate over a given time. Thus, execution of commands by such devices is subject to those constraints. In absence of scheduling such as that provided by embodiments of the invention, the combinations of those constraints limit performance. For example, if information cannot be communicated to or from a device in a timely manner, performance of commands by the device may have to be suspended until the information may be communicated. As another example, if commands cannot be performed as quickly as communication can be communicated over the communication paths, the communication paths may be inefficiently utilized.

Examples of systems in which devices process commands over time include electronic systems, such as integrated circuit systems or, as a more specific example, memory systems. For example, in synchronous dynamic random access memory (DRAM) systems, command transfers from a memory controller to a memory device are typically synchronized to an external clock In such systems, a single command typical occupies the command bus for one or more external clock cycles, as is the case with synchronous DRAM (SDRAM). A command may occupy the bus for multiple clock cycles due to signal integrity reasons. The command bus may also be occupied for multiple cycles if other information associated with the command (such as address or bank select) is multiplexed onto the command bus.

Typically, only one type of command (such as for example, precharge, row activate, read/write, or some additive combination) is sent on a bus at any given time. There may be more than one command bus per device. During the time that one command occupies the bus, no other command is typically sent.

In some cases, regardless of the time the command bus is occupied when a command is transmitted, the controller may be unable to begin a new command on any arbitrary external clock. This can result in reduced performance if the memory device is idle because a command could not be issued by the controller.

In most prior art systems, commands received by the DRAM are executed immediately. Thus, commands are typically executed by the DRAM in the same order and with the same temporal spacing as they are issued by the memory controller on the command bus. Such an approach limits the extent to which commands may be scheduled for a memory device. In such systems, the order of command execution and the relative timing between the commands is determined by the order and timing of the commands issued on the command bus by the controller.

An exception is the column-access-strobe (CAS) command. In some prior-art systems (e.g., concurrent Rambus DRAM or double data rate-II (DDR-II) memory), the CAS command is ‘posted,’ i.e., stored in the DRAM for later execution. In DDR-II systems, the delay associated with a posted CAS command is fixed. In concurrent Rambus DRAM systems, execution of the posted CAS command is triggered by an external strobe signal.

Also, the command bus is generally shared among several memory devices. There may be situations where two commands directed at two different devices would ideally be issued on the command bus at the same time. However, since this is not possible in such systems, the commands had to be transmitted sequentially, which limited performance of the systems.

It would be possible to incorporate into a memory device a register containing a value which corresponds to a delay from the time the command is received until the time the command is performed. However, a fixed delay provided by such a register may not be appropriate for all circumstances, and writing to a register is typically a relatively lengthy process which effectively prevents the value in the register from being changed dynamically without impairing performance.

Thus, a method and apparatus for scheduling device commands that avoids the deficiencies described above is needed.

### BRIEF DESCRIPTION OF THE DRAWINGS

FIG. 1 is a flow diagram illustrating a method for scheduling a device command in accordance with an embodiment of the invention.

FIG. 2 is a block diagram illustrating a controller for scheduling commands and a device in accordance with an embodiment of the present invention.

FIG. 3 is a timing diagram illustrating timing relationships, such as issuance times and performance times of commands in accordance with an embodiment of the invention.

FIG. 4 is a block diagram illustrating a memory system in accordance with an embodiment of the present invention.

FIG. 5 is a block diagram illustrating an exemplary embodiment of a delay block, such as precharge delay block 438, activate delay block 439, or column access delay block 440 of FIG. 4.

FIGS. 6A and 6B show examples of the use of delay fields for various types of commands in accordance with embodiments of the present invention.

### DETAILED DESCRIPTION OF THE INVENTION

Methods and apparatuses for scheduling commands are described. According to various embodiments of the invention, delay information, which is associated with a command, is issued. The delay information directs the device for which the command is intended to either execute the command immediately or to delay the command for some period of time before execution. Multiple commands can be queued for execution within the device.

The delay information associated with the command comprises a value that may be used to determine an amount of delay in a number of ways. For example, the amount of delay may be directly encoded, where the amount of delay corresponds to the value, or the value can be used as an index into a storage entity, which may be programmable or non-programmable (e.g., fixed), such as registers or a lookup table, containing the delay values representative of amounts of delay. Alternatively, some amount of delay may be directly encoded, while another amount of delay for the same command may be obtained by reference to a storage entity, which may be programmable or non-programmable (e.g., fixed). In addition, a command may be associated with a separate delay register, which may be programmable or non-programmable (e.g., fixed), to provide an additional fixed delay to every command. By issuing delay information with a command, the amount of delay may be changed dynamically, as frequently as once per command issued.

In some cases, a minimum granularity of external bus clock cycles applies to the timing of the issuance of commands over an external bus. A device coupled to an external bus typically may require several clock cycles to complete performance of a command. The time required to complete performance of a command may not coincide precisely with the minimum temporal granularity for issuance of commands over the external bus. In such a situation, one or more clock cycles may be lost until all of the conditions of the system are satisfied so that a new command may be issued and performed. Embodiments of the invention may be used to overcome such problems, avoiding lost clock cycles and improving system efficiency and performance characteristics.

In some cases, there are two or more DRAMs coupled to a single command bus. Commands take one or more clock cycles to transmit. A situation may arise, for example, where, for optimal system performance, an activate command directed to a first device and a read command directed to a second device should be transmitted by the controller at the same time (i.e., within the same clock cycle). Transmitting either earlier would violate a timing parameter of the respective DRAM. Transmitting either later would impair performance. In accordance with various embodiments of the invention, one of the commands can be transmitted earlier, and the execution of that command will be delayed by the corresponding DRAM. Thus, both DRAMs will execute their respective commands at the same time, thereby providing optimal system performance, even though the commands were transmitted at different times.

Various embodiments of the invention may be applied to reordering commands. The earlier of two commands can be assigned a delay value much greater than the later of the commands, resulting in a DRAM executing the second command first, and the first command later. This can provide flexibility in systems where the command issue order is constrained in the controller or where some commands can be pre-empted or cancelled by later commands. Thus, the ability to schedule commands so as to overcome limitations in command bus bandwidth or in the manner in which commands are pipelined in a device is provided. Performance may be optimized for minimal latency, maximal effective bandwidth, or some other desirable characteristic which may be achieved through the use of different command timing relationships, for example, depending upon system load and configuration.

In accordance with at least one embodiment of the invention, delay information is transmitted from a controller to a device, wherein the delay information is associated with a command to the device. The information relates to a delay period from the time the command is received by the device until the time the command is executed by the device. The information may be directly representative of a delay value, or may be used to obtain a delay value indirectly, for example, if used as an index to a fixed or programmable on-chip delay table. The delay value can be denominated in any meaningful manner, for example in standardized units of time, such as nanoseconds, or in clock cycles. For example, it can be any integer multiple or sub-multiple (e.g., 4, 2, 1, ½, ¼, etc.) of a clock, such as an external clock provided to the device.

In addition to an amount of delay derived either directly or indirectly from the delay information transmitted from the controller to the device, one or more on-chip registers in the device may be used to add amounts of fixed delay and increase the delay period. Such on-chip registers may be configured to add delay under certain conditions or independent of those conditions. For example, the on-chip registers may be used to increase the delay period in the same or different amounts for one or more specific command types. A mode register may be provided to store information relating to a mode of the device, and such a mode register may be used to enable and disable amounts of fixed delay such as those provided based on values stored in one or more fixed delay registers. Although the term “fixed delay” is used, it is understood that such fixed delay may be set when a device is manufactured or before it is used in normal operation (for example, upon application of power to the device), but that the fixed delay remains relatively fixed thereafter and does not change on a per-command basis.

The device queues the commands it receives in a command queue until their scheduled performance time. Other information associated with a given command (e.g., an address) is also queued so as to be available at the scheduled performance time.

In some embodiments, a precedence mechanism is provided in the device to arbitrate between scheduling conflicts, such as when multiple commands are scheduled to execute in the same device at the same time. As one example, the precedence mechanism provides that the first command received is executed first. As another example, the last command received is executed first. As yet another example, the precedence mechanism may use priority information, associated with a command, to determine the actual performance times of such command and, accordingly, may be used to overcome scheduling conflicts.

The present invention provides a method for the dynamic scheduling of device commands. In one embodiment, the method includes the steps of issuing a device command, issuing delay information in the form of a value, and executing the command at a time determined, at least in part, by the value. In another embodiment, the method comprises the steps of issuing a plurality of commands, issuing a plurality of values wherein each value is representative of delay information associated with one of the commands, and executing each of the commands at a time determined, at least in part, by the associated value. The dynamic scheduling of each command is accomplished by the issuance of delay information which causes the time of the execution of the command to be changed by an amount determined, at least in part, by the value of the delay information.

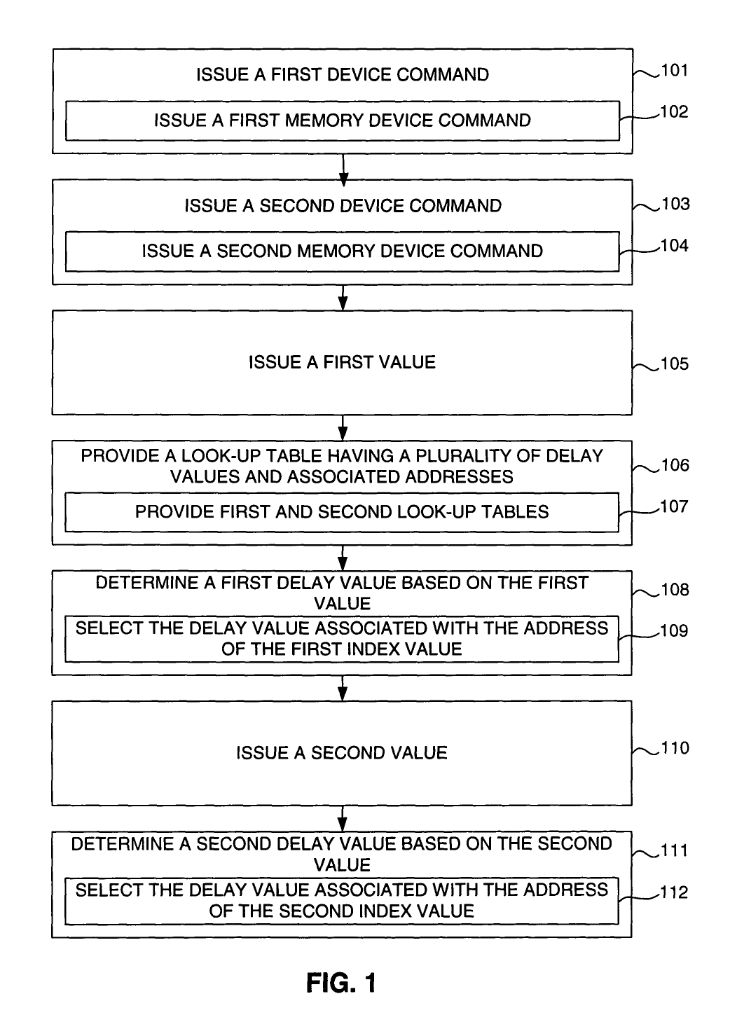

FIG. 1 is a flow diagram illustrating a method for scheduling a device command in accordance with an embodiment of the invention. The method begins in step 101, where a first device command is issued. If the device is a memory device, step 101 comprises step 102, where a first memory device command is issued, and the first performance time is a time at which the first memory device command is to be performed. In step 103, a second device command is issued. If the device is a memory device, step 103 comprises step 104, where a second memory device command is issued, and the second performance time is a time at which the second memory device command is to be performed. In step 105, a first value is issued, which may, for example, be a first index value or a first delay value. If the device is a memory device, the first value is communicated from a memory controller to a first memory device. The first value determines, at least in part, a first performance time at which the first device command is to be performed. The second value determines, at least in part, a second performance time at which the second device command is to be performed. Other factors, such as intrinsic delays in the system, which may include propagation delays of output buffers, wires, and/or input buffers, as well as timing uncertainty that is inherent in the system, may also influence the timing of the first performance time.

The first delay value is representative of delay measured in time units or by the passage of one or more events, such as events occurring within the device. For example, the first delay value may be expressed relative to a standardized unit of time or in units of a clock period, such as a case where the first delay value denotes an integer multiple or submultiple of a clock period. Although the first delay value may be zero, in some preferred embodiments, the first delay value has or connotes a nonzero value, such as a positive (i.e., greater than zero) or negative value (i.e., less than zero).

If the first value is a first index value, the method preferably comprises step 106. In step 106, a look-up table having a plurality of delay values and associated addresses is provided, wherein each of the delay values is associated with one of the addresses and wherein the first index value represents a first address which is one of the addresses in the look-up table. When the second value issued pursuant to step 110 below is a second index value which represents a second address in a look-up table, step 106 preferably comprises step 107. In step 107, a first look-up table and a second look-up table are provided, wherein the first address is associated with the first look-up table and the second address is associated with the second look-up table. The first and second look-up tables may be separate look-up tables or may be the same. A single look-up table may be used in place of the first and second look-up table. The first and second addresses may be the same address or different addresses.

In step 108, a first delay value is determined based on the first value. When the first value is a first index value, the step 108 preferably comprises step 109. In step 109, the delay value is determined by selecting the delay value associated with the address of the first index value. In step 110, a second value is issued, wherein the second value determines, at least in part, a second performance time at which the second device command is to be performed. In step 111, a second delay value based on the second value is determined. When the second value is a second index value, step 111 preferably comprises step 112. In step 112, the delay value is determined by selecting the delay value associated with the address of the second index value. The second index preferably represents a second address in the look-up table(s) described with reference to step 106.

The method may be performed in a variety of different manners. For example, step 101 and/or 102 can occur at a first issuance time and step 105 can occur at a second issuance time. The first and second issuance times may be the same or different. If the first and second issuance times are different, the difference between the first issuance time and the second issuance time is a time gap. The time gap may or may not be predetermined, wherein the time gap is known at or before the first issuance time, or it may or may not be fixed, wherein the time gap remains the same from one command to the next.

A delay occurs between the first issuance time and the first performance time. This delay is determined by the first delay value or by the first delay value and an additional delay value. The additional delay value is not necessarily known or fixed. For example, the additional delay value may be influenced by other factors, such as inherent delays in the system or timing uncertainty of the system.

As another example of how the first delay value may be used in the system, a delay between the first issuance time and a first decoding time at which the first memory device command is decoded may be determined by the first delay value or by the first delay value and an additional delay value. As yet another example, a delay between a first decoding time at which the first memory device command is decoded and the first performance time at which the first memory device command is performed may be determined by the first delay value or by the first delay value and an additional delay value.

As another example of timing relationships in the system, the first performance time may be determined by the first delay value, an additional delay value, and a second delay value, wherein the second delay value is derived from a delay register. The delay register may be programmable or predetermined (i.e., its contents may be programmable or predetermined).

The memory device command referred to above may be, for example, a column access strobe (CAS) command, a precharge command, a row access strobe (RAS) command, a refresh command, a command including the functionality of a refresh command and a RAS command, a command including the functionality of a refresh command and a pre-charge command, a mode register operation command, a power mode command, or another command.

As an example of how a memory device command may be processed, a first parameter associated with the first memory device command may be queued until the first performance time. Such a first parameter may, for example, comprise a memory address or data to be stored in the first memory device.

If a first memory device command and a second memory device command are issued, the step of issuing the first memory device command occurs at a first issuance time, the step of issuing the first value occurs at a second issuance time, the step of issuing the second memory device command occurs at a third issuance time, and the step of issuing the second value occurs at a fourth issuance time. The first issuance time may be the same as or different than the second issuance time; and the third issuance time may be the same as or different from the fourth issuance time. A first difference between the first issuance time and the second issuance time may or may not be of equal duration to a second difference between the third issuance time and the fourth issuance time. In one example, the first difference is known at or before the first issuance time.

The first value may be a first delay value, and the second value may be a second delay value. Alternatively, the first value may be a first index value, and the second value may be a second index value. As another alternative, the first value may be a delay value, and the second value may be an index value. As yet another alternative, the first value may be an index value, and the second value may be a delay value. The second delay value may be the same as or different than the first delay value. The second index value may be the same as or different than the first index value. A delay value (for example, the first value or the second value) may be different from a delay derived from an index value (for example, the second value or the first value, respectively). The first performance time may occur before or after the second performance time.

The first memory device command may be a precharge command, a row access strobe (RAS) command, a refresh command, a command providing the functionality of a refresh command and a RAS command, a command comprising the functionality of a refresh command and a pre-charge command, a mode register operation command, a power mode command, or another command.

In some situations, system performance may be optimized if a first device command is performed by a first device, such as a first memory device, while a second command is performed by a second device, such as a second memory device. For example, system performance may be optimized in some cases when a first performance time at which the first device is performing the first device command temporally overlaps, wholly or partially, a second performance time at which the second device is performing the second device command. In such situations, a controller may issue the first device command to the first device at a different time than it issues the second device command to the second device, yet, by virtue of the scheduling capability described herein, the controller may schedule the first device to perform the first device command at the same time as the second device is scheduled to perform the second device command.

When the first value associated with a first memory command comprises a first index and the second value associated with a second memory device command comprises a second index, a first temporal value associated with a first performance time at which the first memory device command is to be performed may be determined based on the first index, and a second temporal value associated with a second performance time at which the second memory device command is to be performed may be determined based on the second index. The second temporal value may be the same as or different than the first temporal value.

Various techniques may be used to arbitrate between performances of commands that are scheduled to be performed at the same time by the same device. For example, whichever of the first memory device command and the second memory device command is first received at a memory device may be selected to be performed first. As another example, whichever of the first memory device command and the second memory device command is last received at a memory device may be selected to be performed first. As yet another example, if the first memory device command comprises first priority information, and the second memory device command comprises second priority information, the order of performance of the first memory device command and the second memory device command may be determined in accordance with the first priority information and the second priority information. If it is desired for a second memory device command to preempt a first memory device command, the second memory device command can cause reordering of the performance of the first memory device command and the second memory device command, causing the second memory device command (which may have been issued later) to be performed before the first memory device command (which may have been issued earlier). Alternatively, in some situations, it may be appropriate for the second memory device command to cause cancellation of the first memory command. In such situations, even though the first memory device command was issued, the subsequent issuance of the second memory device command before scheduled performance of the first memory device command causes the first memory device command not to be performed. While the foregoing are described in the context of memory device commands, it should be understood that they may be practiced using device commands for devices other than memory devices.

Methods in accordance with the above description may be applied to scheduling commands under a variety of circumstances, for example, when a time gap between issuance of a command and a value associated with that command used for scheduling is fixed, when commands are to be preempted, for example, by being reordered or cancelled, and when commands for multiple devices are scheduled so as to coordinate the timing of operations occurring at these multiple devices and improve system efficiency and performance characteristics.

Besides memory devices, the methods described above may be applied to dynamic scheduling of commands for other types of systems and integrated circuits. For example, a first command of the commands may be used to access data within an integrated circuit device to be communicated to a second integrated circuit device. The first command may be issued by the second integrated circuit device. The first command may include a first temporal value that represents a delay until a first performance time at which the first command is to be performed by the first integrated circuit device.

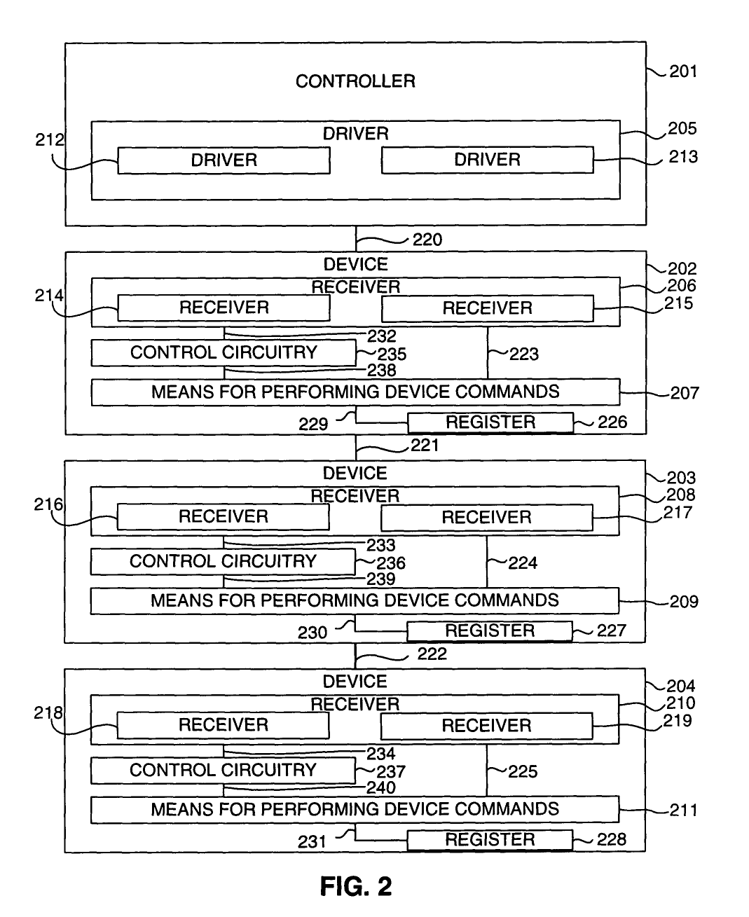

FIG. 2 is a block diagram illustrating a controller for scheduling commands and a device in accordance with an embodiment of the present invention. The controller 201 comprises a driver 205 for issuing commands and associated delay values to at least one device 202 coupled to the controller. In some preferred embodiment, delay values issued by the controller have non-zero values. In some such embodiments, delay values are only issued for commands which will be delayed by a positive or negative value. For commands for which are to be delayed by a zero value (i.e. commands which are not to be delayed), no delay value is issued. A first delay value is associated with a performance time at which the associated command is to be performed by the device. The driver 205 preferably comprises a first driver 212 for issuing commands to the device 202 and a second driver 213 for issuing delay values to the device 202. Alternatively, a single driver 205 may be used to issue both the commands and the delay values. As one example, the controller 201 may be a memory controller and the device 202 may be a memory device.

As an example of the operation of such a controller 201, the driver 205 that issues commands may issue a first command with a first delay value, wherein the first command has a first performance time, and a second command with a second delay value, wherein the second command has a second performance time. The controller 201 may determine performance constraints of the device to determine the first performance time and the second performance time. For example, the performance constraints may be dependent upon a physical location of the device 202 relative to the controller 201, such as being dependent upon a propagation delay affecting reception of the first command at the device or a propagation delay affecting reception of the data from the device. As another example, the performance constraints are dependent upon a state of the device. As yet another example, the performance constraints are dependent upon an operational speed limitation of the device. As a further example, the performance constraints are dependent upon a difference in timing granularity between an internal bus 223 of the device and an external bus 220 coupling the device to the controller. The controller 201 of FIG. 2 is capable of being used in accordance with the methods described in reference to FIG. 1.

The device 202 of FIG. 2 comprises a receiver 206 for receiving a first device command and a first value associated with the first device command (and optionally a second device command and a second value associated with the second device command), means 207 for performing the first device command at the first performance time and the second device command at the second performance time, and control circuitry 235 for controlling the means 207 to cause the means to perform the first device command at the first performance time. A first performance time is associated with the first index and a second performance time is associated with the second index. The device 202 may or may not be a memory device. If it is, the first device command may be a first memory device command and the second device command may be a second memory device command. The receiver 206 comprises a first receiver 214 for receiving the first device command and a second receiver 215 for receiving the second device command. Optionally, the first receiver 214 is also for receiving the first index and the second receiver 215 is also for receiving the second index. As an example, the first and second receivers 214 and 215 may be configured to receive the first and second device commands and the first and second indices from the controller 201, which, in the case of a memory device, is a memory controller. As yet another example, the first receiver 214 receives the first device command, the second receiver 215 receives the first value, then the first receiver 214 receives the second device command, and the second receiver 215 receives the second value. The receiver 206 is coupled to the means 207 for performing device commands by the internal bus 223. The receiver 206 is coupled to control circuitry 235 by the internal bus 232. The control circuitry 235 is coupled to the means 207 by internal bus 238.

The device 202 further comprises a register 226 coupled to the means 207 for performing device commands and/or the receiver 206 via internal bus 229. When the register is used, the first performance time is dependent on the first delay value and an additional delay value derived from a stored value stored in the register. The device 202 is capable of accepting multiple commands with multiple values from controller 201. The commands are scheduled in accordance with the values, allowing various temporal relationships between the performance times of the commands to be achieved. For example, the device 202 may be configured such that the receiver 206 first receives the first command and the first delay value, then later receives the second command and the second delay value, wherein the device 202 performs the second command before performing the first command. Buses 223, 229, 232, and/or 238 may be the same or different buses.

Means 207 for performing device commands may be of a type well known to those of ordinary skill in the art. For example, if device 202 is a memory device, means 207 for performing device commands may comprise circuits of the type typically used for performing memory device commands, such as read commands, write commands, refresh commands, row precharge commands, row access strobe (RAS) commands, mode register operation commands, power mode commands, or commands combining the functionality of several of the foregoing commands, such as a command comprising a refresh command and a RAS command or a command comprising a refresh command and a pre-charge command. Alternatively, for other types of devices, means 207 for performing device commands may comprise circuits of the type typically used for performing commands in those types of devices, which may include, for example, microprocessors, digital signal processing (DSP) devices, video processing devices, audio processing devices, communication devices, storage devices, memory controllers, input devices, output devices, devices providing both input and output capabilities, and other types of devices.

Control circuitry 235 comprises circuitry for controlling means 207 to cause means 207 to perform a first device command at a first performance time, wherein the first performance time is associated with a first value associated with a first device command received by receiver 206. For example, when receiver 206 receives a first device command, receiver 206 may pass a first value contained in or received with the first device command to control circuitry 235 or may convert information associated with the first device command into a first value, which receiver 206 then passes to control circuitry 235. Control circuitry 235 then communicates with means 207 for performing device commands to cause means 207 to perform the first device command at the first performance time.

Commands to be performed may include commands that result in communication over a data bus of information resulting from the execution of those commands, which may be referred to as data-bus commands, and/or commands that do not result in such communication over the data bus, which may be referred to as non-data-bus commands. Non-data bus commands may involve data bus communication, such as communication of the command from a controller to a device, but communication over a data bus of information resulting from the execution of the command. Examples of non-data-bus commands include precharge commands, recharge commands, and other types of non-data-bus commands. Examples of data-bus commands include commands that result in asserting information onto a data bus, such as a read command, and commands that result in storing information present on a data bus, such as a write command.

Processing of a non-data-bus command includes receiving the command, decoding the command, and executing the command. When a first value is associated with a first device command, a single decoding process may be used for decoding related to the first value and for decoding related to other information, such as the type of device command and the parameters associated therewith other than the first value. As another example, one decoding process may be used for decoding related to the first value, and another decoding process may be used for decoding related to other information. Such decoding processes may occur at the same or overlapping times or at different times. Also, communication of the first value and the first device command may occur together (e.g., at the same time or sequentially consecutive times) or separately (e.g., non-consecutively).

Processing of a data-bus command includes the steps described above in relation to the processing of a non-data-bus command, followed by the step of bus communication of information consequent to the execution of the command. This bus communication occurs after internal processes (i.e., processes that occur internal to the device and do not involve the bus communication activity). Such internal processes include receiving processes and decoding processes, as described above, as well as any internal processes related to preparing a device for the step of bus communication of information consequent to the execution of the command (e.g., processes for executing the command). In the case of a non-data-bus command, such internal processes include processes for receiving, decoding, and executing the command, as described above.

In accordance with embodiments of the invention, a delay in accordance with a value associated with a device command may be provided before the device command is executed. Such a delay may occur before, after, or during a single decoding process or before, after, during, or between multiple decoding processes (e.g., wherein one decoding process relates to decoding a value associated with a performance time and another process relates to decoding other information (e.g., the type of device command and the parameters associated therewith except for the value associated with the performance time). Thus, both execution of the device command may occur after a delay associated with a value associated with a device command has elapsed. For a data-bus command, both execution and bus communication activity may occur after a delay associated with a value associated with a device command has elapsed.

A delay in accordance with a value associated with a device command may be provided before all internal processes associated with performance of a device command are completed. For a data-bus command, one or more steps of one or more internal processes that are prerequisite to bus communication of information consequent to execution of the device command may be performed after the delay has occurred. For a non-data-bus command, processing activity may occur in the device after the delay has occurred.

Several periods of time can defined for activities related to processing of a device command. For example, prior to the beginning of the decoding of the device command, a pre-decoding period may be defined. Receiving of the device command at the device occurs during this pre-decoding period. After the beginning of the decoding of the device command and before execution of a device command has been completed, a pre-execution period may be defined. After execution of a device command has been completed, but before bus communication of information consequent to execution of the device command occurs, a post-execution period can be defined. A delay may be provided during one or more of these periods. For example, a delay may be provided during the pre-decoding period or during the pre-execution period. As another example, a first portion of an aggregate amount of delay may be provided during the pre-decoding period and a second portion of the aggregate amount of delay may be provided during the pre-execution period. Alternatively, a portion or all of the delay may be provided during the post-execution period.

While delay may be provided during one or more of the above periods, providing the delay earlier in the processing of a device command can be particularly advantageous. For example, by introducing the delay in the pre-decoding period, both decoding and executing of the device command can be deferred, allowing elements of the device utilized for decoding and executing the device command to be beneficially applied to processing of other device commands. As another example, by introducing the delay in the pre-execution period, some or all of the execution of the device command can be deferred, allowing elements of the device utilized for executing the device command to be beneficially applied to processing of other device commands. Such deferral can be particularly advantageous in situations wherein a device command may be preempted or modified by a subsequently issued device command. For example, if decoding and execution of a device command is deferred until after a time at which that device command is preempted, decoding and execution of that device command can be avoided, freeing the elements of the device utilized for decoding and execution to be beneficially applied to processing of other device commands and improving device performance. Preemption of a device command may include cancellation of the device command and/or replacement of the device command with another device command.

While the foregoing description of FIG. 2 has referred to controller 201 and receiver 202 and communication between those elements, it should be understood that controller 201 may be coupled to multiple devices, for example, including devices 203 and 204. Device 203 is coupled to external bus 221, and device 204 is coupled to external bus 222. External buses 221 and 222 may be different buses than external bus 220 or they may form a single bus with external bus 220, either as one contiguous bus or as bus segments carrying information common to both. Device 203 comprises a receiver 208, means 209 for performing device commands, control circuitry 236 for controlling the means 209, and one or more registers 227. Receiver 208 is coupled to means 209 via internal bus 224, and means 209 is coupled to registers 227 via internal bus 230. The receiver 208 is coupled to the control circuitry 236 via internal bus 233. The control circuitry 236 is coupled to means 209 for performing device commands via internal bus 239. Internal buses 224, 230, 233 and/or 239 may be the same bus or different buses. Receiver 208 may include receivers 216 and 217, wherein receiver 216 may be used to receive commands from controller 201 and receiver 217 may be used to receive values associated with those commands, such as delay values or index values for scheduling the commands. Control circuitry 236 and means 209 may be implemented as described above with respect to control circuitry 235 and means 207.

Device 204 comprises a receiver 210, means 211 for performing device commands, control circuitry 237 for controlling the means 211, and one or more registers 228. Receiver 210 is coupled to means 211 via internal bus 225, and means 211 is coupled to registers 228 via internal bus 231. The receiver 210 is coupled to the control circuitry 237 via internal bus 234. The control circuitry 237 is coupled to means 211 for performing device commands via internal bus 240. Internal buses 225, 231, 234, and/or 240 may be the same bus or different buses. Receiver 210 may include receivers 218 and 219, wherein receiver 218 may be used to receive commands from controller 201 and receiver 219 may be used to receive values associated with those commands, such as delay values or index values for scheduling the commands. Control circuitry 237 and means 211 may be implemented as described above with respect to control circuitry 235 and means 207.

Although in some embodiments of the present invention, the controller is responsible for scheduling, as well as issuing commands, in other embodiments, some or all of the scheduling may be completed by the memory device, including for example issuing delay information for commands.

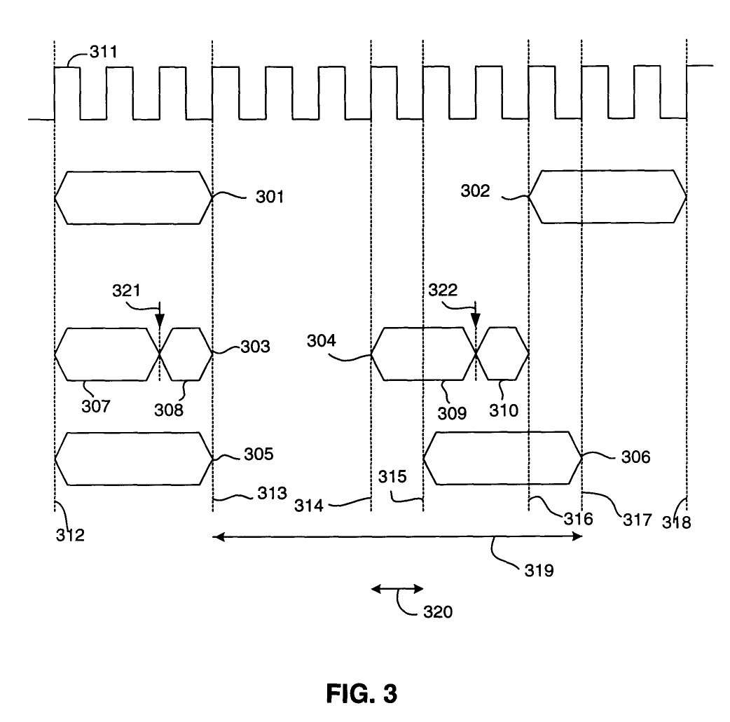

FIG. 3 is a timing diagram illustrating timing relationships, such as issuance times and performance times of commands in accordance with an embodiment of the invention. The timing diagram is illustrated with reference to a clock signal 311, such as a clock used for timing reference for external bus 220 of FIG. 2. In a first example illustrated in FIG. 3, which does not utilize dynamic scheduling of commands, a first command 301 is issued at time 312 and performed immediately after issuance at time 313. Due to system constraints, as illustrated by duration 319, execution of a second command 302 cannot begin until time 317. However, due to other system constraints, commands are only issued on integer multiples of clock signal 311 (in the illustrated example, three clock cycles of clock signal 311). Since time 317 does not fall at the end of such a multiple, the second command 302 is issued at time 316 such that the end of its transmission coincides with time 318 at the end of such a multiple. Thus, two clock cycles between time 317 and time 318 are lost while waiting to satisfy the system constraints.

However, such loss can be avoided in accordance with the second example, which utilizes dynamic scheduling of commands. In the second example, a first command 303, includes command 307 and value 308 associated with command 307. The first command 303 is issued at a first issuance time 312, with command 307 being issued at first issuance time 312 and value 308 being issued at a second issuance time 321. While first command 303 is illustrated as being queued for performance at time 313 immediately after issuance (shown as command 305), it should be understood that the first command 303 may be scheduled for a different time in accordance with information contained in or referred to by value 308. As noted above, the system constraints illustrated by duration 319 prevent performance of a second command until time 317. However, by scheduling a delay for the performance of the second command 304 until time 317, optimal timing for the performance of the second command 304 can be achieved. The second command 304 includes command 309 and value 310 associated with command 309. The second command 304 is issued at time 314, and the issuance ends at time 316. Value 310 specifies scheduling such that command 309 is queued to begin being decoded at time 315 and is performed at a second performance time at time 317. Thus, command 304 is effectively delayed by a delay value indicated by duration 320. Thus, precise timing of the performance of commands can be provided even when system constraints limit the ability to control timing of the issuance of commands. It should be noted that, to avoid confusion, other delays, such as propagation delays, as well as other timing concerns, such as set-up and hold time requirements have not been illustrated, but are understood to affect timing relationships in any non-idealized system.

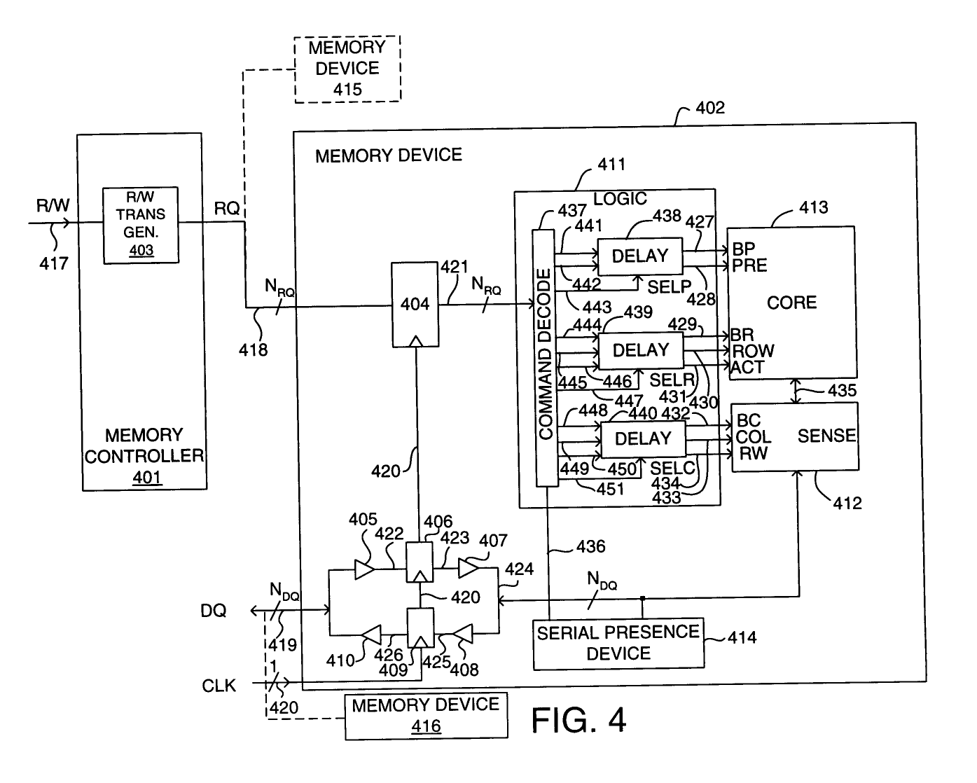

FIG. 4 is a block diagram illustrating a memory system in accordance with an embodiment of the present invention. The memory system comprises a memory controller 401 and a memory device 402. Optionally, the memory may include one or more other memory devices, such as memory devices 415 and 416.

Memory controller 401 is coupled to memory device 402, and optionally to other memory devices such as memory device 415, via RQ bus 418, which has a bus width of N_{RQ} bits. Memory controller 401 comprises read/write (R/W) transaction generator 403. R/W transaction generator 403 receives a R/W input 417 and produces control signals that are transmitted to memory device 402 via RQ bus 418.

Memory device 402 is coupled to DQ bus 419, which has a bus width of N_{DQ} bits. DQ bus 419 passes data being written to or read from memory device 402. DQ bus 419 may also be coupled to memory controller 401 and/or to other memory devices, such as memory device 416.

Memory device 402 is coupled to clock bus 420, which typically has a bus width of one bit, although larger bus widths may optionally be used. Clock bus 420 passes one or more clock signals that may serve as a timing reference. Clock bus 420 may also be coupled to memory controller 401 and/or to other memory devices.

Memory device 402 comprises RQ register 404, inbound DQ receiver 405, inbound DQ register 406, inbound DQ driver 407, outbound DQ receiver 408, outbound DQ register 409, outbound DQ driver 410, logic block 411, sense block 412, and core 413. RQ bus 418 is coupled to an input of RQ register 404. RQ register 404 provides RQ output 421, which preferably has a bus width of N_{RQ} and is coupled to logic block 411. DQ bus 419 is coupled to an input of inbound DQ receiver 405 and to an output of outbound DQ driver 410. Inbound DQ receiver 405 provides an output 422, which is coupled to inbound DQ register 406. Inbound DQ register 406 provides an output 423, which is coupled to inbound DQ driver 407. Inbound DQ driver 407 provides an output to an internal DQ bus 424 of memory device 402. Internal DQ bus 424 of memory device 402 is coupled to sense block 412, to serial presence device 414, and to an input of outbound DQ receiver 408. Outbound DQ receiver 408 provides an output 425, which is coupled to outbound DQ register 409. Outbound DQ register 409 provides an output 426, which is coupled to an input of outbound DQ driver 410. Output 422, output 423, internal DQ bus 424, output 425, and output 426 all preferably have a bus width of N_{DQ}.

Within memory device 402, control signals from the RQ bus 418 are clocked into RQ register 404, which may comprise, for example, D flip-flop circuits, in accordance with a clock signal from clock bus 420, which is coupled to RQ register 404. Data signals from DQ bus 419 are clocked into inbound DQ register 406, which may comprise, for example, D flip-flop circuits, in accordance with a clock signal from clock bus 420, which is coupled to inbound DQ register 406. Data signals from sense block 412 or serial presence device 414 are clocked into outbound DQ register 409, which may comprise, for example, D flip-flop circuits, in accordance with a clock signal from clock bus 420, which is coupled to outbound DQ register 409.

Logic block 411 comprises command decode block 437, precharge delay block 438, activate delay block 439, and column access delay block 440. RQ output 421 from RQ register 404 is coupled to command decode block 437. Command decode block 437 provides a control output 436 to serial presence device 414. Serial presence device 414 is preferably implemented using a non-volatile memory device, such as a read-only memory (ROM) device in which information pertaining to operational parameters of memory device 402 or other information may be stored. Memory controller 401 may obtain such information from serial presence device 414, for example, by interrogating memory device 402 via RQ bus 418.

Command decode block 437 provides a bank address for a pre-charge operation (“BP”) output 441, a precharge operation (“PRE”) output 442, and a delay select value for a precharge operation (“SEL P”) output 443 to precharge delay block 438. Precharge delay block 438 provides a BP output 427 and a PRE output 428 to core 413. BP output 427 and PRE output 428 may be delayed relative to BP output 441 and PRE output 442, in accordance with aspects of the present invention. Command decode block 437 provides a bank address for a row operation (“BR”) output 444, a row address for a row operation (“ROW”) output 445, an activate operation (“ACT”) output 446, and a delay select value for a row operation (“SEL R”) output 447 to activate delay block 439. Activate delay block 439 provides a BR output 429, a ROW output 430, and an ACT output 431 to core 413. BR output 429, ROW output 430, and ACT output 431 may be delayed relative to BR output 444, ROW output 445, and ACT output 446, in accordance with aspects of the present invention. Command decode block 437 provides a bank address for a column operation (“BC”) output 448, a column operation (“COL”) output 449, a read/write selection control (“RW”) output 450, and a delay select value for a column operation (“SEL C”) output 451 to column access delay block 440. Column access delay block 440 provides a BC output 432, a COL output 433, and a RW output 434 to sense block 412. BC output 432, COL output 433, and RW output 434 may be delayed relative to BC output 448, COL output 449, and RW output 450, in accordance with aspects of the present invention.

Plural instances of delay blocks, such as precharge delay block 438, activate delay block 439, and column access delay block 440 may be implemented to allow more than one command to be delayed, in accordance with aspects of the present invention. When plural instances of delay blocks are provided, command decode block 437 may direct control signals (e.g., BP output 441, precharge output 442, SEL P output, etc.) to any of the plural instances of delay blocks that are not currently holding valid control information. Thus, after the specified delay for a particular instance of delay blocks elapses, that particular instance of delay blocks becomes available to be used for delaying new control signals being provided by command decode block 437. After any delays provided by logic block 411, signals for controlling a memory operation are provided to sense block 412 and core 413, and the corresponding memory operation is performed

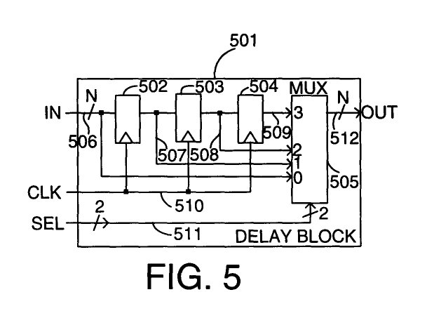

FIG. 5 is a block diagram illustrating an exemplary embodiment of a delay block, such as precharge delay block 438, activate delay block 439, or column access delay block 440 of FIG. 4. Delay block 501 receives an input 506, which has a bus width of N bits, N representing a positive integer. Input 506 is coupled to an input of delay element 502, which may, for example, comprise D flip-flops, and to a 0 input of multiplexer 505. An output 507 of delay element 502 is coupled to an input of delay element 503, which may, for example, comprise D flip-flops, and to a 1 input of multiplexer 505. An output 508 of delay element 503 is coupled to an input of delay element 504, which may, for example, comprise D flip-flops, and to a 2 input of multiplexer 505. An output 509 of delay element 504 is coupled to a 3 input of multiplexer 505. A clock input 510 is provided to clock terminals of delay elements 502, 503, and 504.

A selection input 511 having a bus width sufficient to allow selection of an input among the inputs of multiplexer 505 is provided to multiplexer 505. In the illustrated example, a bus width of two is sufficient to select among the four inputs (i.e., the 0, 1, 2, and 3 inputs) of multiplexer 505, when using binary signaling. Multiple instances of delay block 501 may be implemented within precharge delay block 438, activate delay block 439, and column access delay block 440 of FIG. 4. For example, two instances may be implemented within precharge delay block 438 to accommodate BP output 441 and PRE output 442, while three instances may be implemented within activate delay block 439 to accommodate BR output 444, ROW output 445, and ACT output 446. Appropriate selection inputs may be provided to corresponding delay blocks, for example, SEL P output 443 may be provided as selection input 511 for precharge delay block 438, SEL R output 447 may be provided as selection input 511 for activate delay block 439, and SEL C output 451 may be provided as selection input 511 for column access delay block 440.

Depending on the value presented by selection input 511, multiplexer 505 selects among its inputs to provide an output 512. Output 512 has a bus width of N bits. Output 512 may be used as BP output 427 or PRE output 428 (of precharge delay block 438), as BR output 429, ROW output 430, or ACT output 431 (of activate delay block 439), or as BC output 432, COL output 433, or RW output 434 (of column access delay block 440), for example.

In at least one embodiment of the present invention, a memory controller may communicate with a memory device via request packets sent over an RQ bus. Different packet formats may be used for different types of request packets. Each packet format may include a delay field, which contains a value such as value 308 or value 310 of FIG. 3. For example, in one embodiment, the delay field associated with an activate command, a read command, or a write command permits the execution of such command by the memory device to be delayed by 0 or 1 clock cycle, while the delay field associated with a precharge command, permits the execution of the precharge command by the memory device to be delayed by from zero to three clock cycles. These fields permit the activate, read, write, precharge, and refresh command packets to be efficiently slotted at the RQ interface of the memory component, regardless of the exact value of the various timing parameters (for example, t_{RCD}, t_{CC}, t_{RDP}, t_{WRP}, and t_{RP}) that determine the separation of the request packets.

As described above, the delay field may be used to align memory operations in order to improve utilization of the RQ bus. However, the delay field may be additionally or alternatively used to align multiple memory operations so as to avoid electrical interference. This alignment can prevent a current supply pulse from one type of memory operation from interfering with another type of memory operation. With the delay feature, commands can be ordered such that the synchronized, combined current supply pulse from multiple memory operations will not be excessive.

In accordance with at least one embodiment of the invention, each of the delay blocks is a configurable delay register. A configurable delay register for precharge and/or refresh commands preferably includes three sub-registers, each imposing one clock cycle of delay. Nb bank address lines connect through the three sub-registers and a multiplexer, wherein Nb is a positive integer. Based on the control signals on the corresponding selection input, the multiplexer selects zero, one, two, or three clock delays and provides the resulting bank address signals at the output of the multiplexer. The output of the multiplexer may, for example, be provided to a decoder that decodes the Nb-bit signal to 2^{Nb} bank select lines, each of which connects to a precharge terminal of a corresponding memory bank. The remaining data-access and refresh registers are similarly constructed to produce either two or four possible increments of delay. For example, configurable delay registers for precharge and refresh commands may be configured to provide zero, one, two, or three clock cycles of delay, while configurable delay registers for activate or column access (e.g., read or write) commands may be configured to provide zero or one clock cycles of delay. In many systems, delay registers configured to provide from zero to three clock cycles of delay for precharge and refresh commands and zero to one clock cycle of delay for activate or column access commands will provide sufficient flexibility to significantly improve RQ bus utilization. Alternatively, configurable delay registers may be configured to provide different possible numbers of clock cycles of delay.

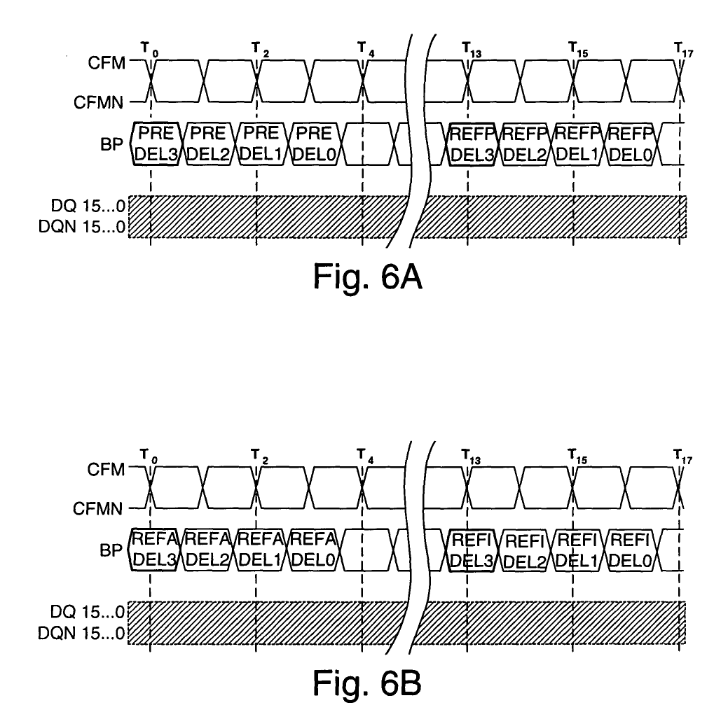

FIGS. 6A and 6B show examples of how delay fields are used in some embodiments. In FIG. 6A, a request packet having a PRE command present at cycle T0 is depicted. The delay (“DEL”) field is set to “11,” a binary three, which provides a delay of zero clock cycles. This request packet is equivalent to a packet with a PRE command at cycle T1 and the delay field set to “10”. It is also equivalent to a request packet with a PRE command at cycle T2 and a delay field set to “01”. It is also equivalent to a request packet with a PRE command at cycle T3 and a delay field set to “00.” The equivalent packets are depicted adjacent one another. This equivalence can be used when analyzing request packet interactions.

To the right of FIG. 6A, a packet having a refresh-precharge (“REFP”) command present at cycle T13 is depicted. The DEL field is set to “11.” This request packet will be equivalent to a packet with a REFP command at cycle T14 and the delay field set to “10,” a packet with a REFP command at cycle T15 and the delay field set to “01,” or a packet with a REFP command at cycle T16 and the delay field set to “00.”.

The left and right sides of FIG. 6B respectively depict equivalent packets for refresh-activate (“REFA”) and refresh-increment (“REFI”) commands. The use of the delay function with REFA and REFI commands is essentially identical to the example just described for the REFP command; a discussion of the delay function of the REFA and REFI commands is therefore omitted for brevity.

In addition to the above-described precharge and refresh commands, embodiments of the present invention may also be applied to other commands, for example, activate commands and column access commands (e.g., read commands and write commands). While the use of a two-bit selection input to select among four possible delay values has been discussed in the context of precharge and refresh commands, other numbers of bits of selection inputs may be used to select among other numbers of possible delay values for other types of commands. For example, a one-bit selection input may be used to select among two possible delay values for activate and column access commands. As a more detailed example, one value of a one-bit selection input may be used to specify a delay of zero clock cycles (i.e., no additional delay), while an alternative value of a one-bit selection input may be used to specify a delay of a finite number of clock cycles, such as one clock cycle. In such an embodiment, an activate or column access command specifying a delay of one clock cycle sent on a first clock cycle would yield equivalent results to a similar command specifying a delay of zero clock cycles sent on a second clock cycle immediately following the first clock cycle. However, the ability to achieve equivalent results from commands sent on different clock cycles allows use of the most convenient of those different clock cycles for actually sending a command, thereby allowing more efficient use of command bus (e.g., RQ bus) bandwidth

The use of selection inputs comprising one or more bits has been described above in the context of a systems using binary signaling protocols where a single bit (or symbol) represents one of two states, typically a “1” or a “zero”. The present invention may also be used in systems using multi-level signaling protocols where a single symbol is used to represent one of three or more states.

Conceptually, the implementation of delay in accordance with at least one embodiment of the present invention yields results of performance of a command as would be the case if the command were sent on a later clock cycle. However, it should be noted that embodiments of the present invention may provide additional benefits, for example, by allowing results of performance of a command to simulate sending the command even on a later clock cycle for which such action would not otherwise be permissible as a consequence of system timing constraints. As a more detailed example, if system timing constraints were to allow commands to be sent only on certain multiples of clock cycles, for example, at three-clock-cycle intervals, an embodiment of the present invention could be practiced to allow delay of finer granularity (e.g., one-clock-cycle granularity).

It should be noted that various embodiments of the present invention may be advantageously applied to a variety of memory system topologies. For example, one type of memory topology is referred to as “point-to-point” in that interconnects are provided directly between a memory controller and a memory device without continuing to additional memory devices. Another type of memory topology is referred to as “multidrop” in that multiple connections (i.e., “drops”) of an interconnect are coupled to multiple memory devices, as well as to one or more memory controllers. Moreover, a memory system may include aspects of both “point-to-point” and “multidrop” memory topologies. Such memory systems may be referred to as having a “matrix” topology. For example, a memory system may include an RQ bus having a “multidrop” topology and a DQ bus having a “point-to-point” topology. Appropriate embodiments of the present invention may be practiced in the contexts of any such memory system topologies or other memory system topologies.

As an example of a situation in which an embodiment of the present invention may be beneficially applied, one may consider modern memory systems whose operation may be referred to as “overlapped,” “interleaved,” or “pipelined.” In such memory systems, multiple memory operations may be occurring simultaneously. For example, a combination of several (e.g., four) memory operations including zero or more of each of precharge operations, activate operations, column access operations (e.g., read operations and/or write operations), and refresh operations may be occurring simultaneously. As several elements of information may have to be specified via an RQ bus for each memory transaction, interference among such elements of information could occur on the RQ bus. However, embodiments of the present invention may be employed to avoid such interference.

Elements of information that are to be communicated over a bus may be scheduled in accordance with an embodiment of the present invention so that they are communicated as efficiently as possible. Such efficiency may be achieved by communicating as much information as possible per unit time. While the bandwidth of a bus places a limit on such efficiency, actual performance would typically be lower than such bandwidth limits if temporal gaps in the communication of such information were allowed to occur, as might be necessary in absence of benefits provided by embodiments of the present invention. However, by recognizing when such gaps would otherwise occur and scheduling bus communication to avoid, or at least minimize, the occurrence of such gaps, memory system performance can be optimized. Such recognition may be achieved in a variety of ways.

As one example, a memory controller may be provided with processing capability sufficient to determine the optimum scheduling in real time based on the memory operations that are to occur and the system constraints. Alternatively, a simpler way to achieve similar results is to program a memory controller to recognize patterns of memory operations and to perform predetermined scheduling in response to such pattern recognition. As a subset of such an approach, a memory controller may be programmed to respond to a particular stimulus or stimuli with predetermined scheduling.

A memory controller may obtain information relevant to memory operation scheduling in a variety of ways. For example, a memory controller may be preprogrammed with certain information about memory devices of the memory system. Alternatively, a memory controller may perform actions to gather information about the memory system (e.g., characteristics of the memory devices and their interconnects), for example, shortly after power is applied to a memory system, at predetermined times during operation of a memory system, in response to a stimulus or stimuli (e.g., hot swap of memory devices or detected change in performance of the memory system). As an example of one way in which a memory controller may gather information about a memory system, some memory devices include a non-volatile memory device, such as a read-only memory (ROM) memory device, which may be referred to as a serial presence device (SPD), that stores information concerning characteristics of the memory device. A SPD may be programmed with such information at the time it is manufactured, and such information may be obtained from the device by querying the device. Thus, a memory controller may query the SPD of a memory device to obtain information about its operational characteristics, and that information may be used by the memory controller to determine optimum scheduling of bus communication to optimize memory system performance.

Terminology

The term “signal” refers to a stream of information communicated between two or more points within a system. An analog signal holds information directly as the value of some measured quantity, such as voltage. Such a value varies continuously over some range. A digital signal also holds information as values of some measured quantity. However, the allowed values in such a context are limited to a set of non-overlapping ranges. Each such value range encodes for a symbol. Typically the symbols used are “bits,” in which two value ranges represent the “zero” and “one” symbols. Other symbol sets are possible. The measured quantity commonly used to represent the zero and one symbols are voltage levels, although alternatives are possible.

An “interconnect” is the physical medium used by a signal to travel from one point to another. Interconnects typically include one or more conducting wires surrounded by an insulating material, with another conducting sheet or wire to serve as a voltage reference or current return path.

A “system” may, for example, consist of circuit blocks contained within discrete integrated devices or components that are mounted on a substrate such as, for example, a printed circuit board (PCB). The devices or components use interconnects constructed from the wire layers within the PCB. A device or component typically contains interface circuitry that transmits signals onto interconnects as well as interface circuitry that receives signals from the interconnects. Alternatively, a “system” may, for example, consist of discrete circuit blocks that are contained within a single discrete integrated device or component. The blocks use interconnects constructed from the wire layers within the integrated device or component. A block contains interface circuitry that transmits signals onto the interconnects. A block also contains interface circuitry that receives signals from the interconnects.

The mapping of a signal onto an interconnect involves tradeoffs related to system speed. The use of one physical wire per signal (single-ended-signaling) uses fewer wires. The use of two physical wires per signal (differential-signaling) permits higher signaling rates. The mapping of a signal onto an interconnect can also involve optimization related to system resources. Two signals can share the same interconnect (i.e., they are time-multiplexed) to minimize the number of interconnects. Typically, this is done so that the potential timing conflicts that result are acceptable with respect to system performance. The present invention may be implemented in systems using single-ended, differential or other signaling protocols.

Some devices and components are shown directly connected to one another while others are shown connected via intermediate components. In each instance the method of interconnection establishes some desired electrical communication between two or more circuit nodes, or terminals. Such communication may often be accomplished using a number of circuit configurations, as will be understood by those of skill in the art.

Accordingly, a method and apparatus for scheduling a device command has been described. It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. A method for scheduling a device command comprising:
issuing a first device command; and
issuing a first value, wherein the first value determines, at least in part, a first performance time at which the first device command is to be performed.

2. The method of claim 1, wherein the step of issuing a first device command comprises:
issuing a first memory device command and the first performance time is a time at which the first memory device command is to be performed.

3. The method of claim 2, wherein the step of issuing a first memory device command occurs at a first issuance time and the step of issuing a first value occurs at a second issuance time.

4. The method of claim 3, wherein the first issuance time and the second issuance time are different.

5. The method of claim 4, where the difference between the first issuance time and the second issuance time is a time gap.

6. The method of claim 5, wherein the time gap is predetermined.

7. The method of claim 5, wherein the time gap is fixed.

8. The method of claim 3, wherein the first value is a first delay value.

9. The method of claim 8, wherein the first delay value is expressed relative to a standardized unit of time.

10. The method of claim 8, wherein the first delay value is expressed in units of a clock period.

11. The method of claim 8, wherein the first delay value denotes an integer multiple of a clock period.

12. The method of claim 8, wherein the first delay value denotes a submultiple of a clock period.

13. The method of claim 8, wherein the first delay value has a positive or negative value.

14. The method of claim 13, wherein the first delay value has a value greater than zero.

15. The method of claim 13 wherein a delay between the first issuance time and the first performance time is determined by the first delay value and an additional delay value.

16. The method of claim 13, wherein a delay between the first issuance time and a first decoding time at which the first memory device command is decoded is determined by the first delay and an additional delay value.

17. The method of claim 13 wherein a delay between a first decoding time at which the first memory device command is decoded and the first performance time is determined by the first delay value and an additional delay value.

18. The method of claim 13, wherein the first issuance time and the second issuance time are the same.

19. The method of claim 13, wherein the first issuance time and the second issuance time are different, and the difference is a time gap.

20. The method of claim 19, wherein the time gap is predetermined.

21. The method of claim 20, wherein the first memory command is a column access strobe (CAS) command.

22. The method of claim 19, wherein the time gap is known at or before the first issuance time.

23. The method of claim 8 wherein the first memory device command is a precharge command.

24. The method of claim 8 wherein the first memory device command is a row access strobe (RAS) command.

25. The method of claim 8 wherein the first memory device command is a refresh command.

26. The method of claim 8 wherein the first memory device command comprises a refresh command and a row access strobe (RAS) command.

27. The method of claim 8 wherein the first memory device command comprises a refresh command and a pre-charge command.

28. The method of claim 8 wherein the first memory device command is a mode register operation command.

29. The method of claim 8 wherein the first memory device command is a power mode command.

30. The method of claim 8, wherein a first parameter associated with the first memory device command is queued until the first performance time.

31. The method of claim 30 wherein the first parameter comprises a memory address.

32. The method of claim 31 wherein the first parameter comprises data to be stored in the first memory device.

33. The method of claim 2 wherein the first value is communicated from a memory controller to a first memory device.

34. The method of claim 1, further comprising:
issuing a second device command; and
issuing a second value, wherein the second value determines, at least in part, a second performance time at which the second device command is to be performed.

35. The method of claim 34, wherein the step of issuing a first device command comprises issuing a first memory device command, the step of issuing a second device command comprises issuing a second memory device command, the first performance time is a first time at which the first memory device command is to be performed, and the second performance time is a second time at which the second memory device command is to be performed.

36. The method of claim 35, wherein the step of issuing the first memory device command occurs at a first issuance time, the step of issuing the first value occurs at a second issuance time, the step of issuing the second memory device command occurs at a third issuance time, and the step of issuing the second value occurs at a forth issuance time.

37. The method of claim 36, wherein the first issuance time is the same as the second issuance time; and the third issuance time is the same as the fourth issuance time.

38. The method of claim 37, wherein the first issuance time and the third issuance time are different.

39. The method of claim 38, wherein a first difference between the first issuance time and the second issuance time is of equal duration to a second difference between the third issuance time and the fourth issuance time.

40. The method of claim 39 wherein the first difference is known at or before the first issuance time.

41. The method of claim 38, wherein the first value is a first delay value and the second value is a second delay value.

42. The method of claim 41, wherein the second delay value is different than the first delay value.

43. The method of claim 35, wherein the second delay value is the same as the first delay value.

44. The method of claim 35, wherein the first performance time is after the second performance time.

45. The method of claim 3, wherein the first value is a first index value.

46. The method of claim 45, wherein a first parameter associated with the first memory device command is queued until the first performance time.

47. The method of claim 45 wherein the first memory device command is a precharge command.

48. The method of claim 45 wherein the first memory device command is a row access strobe (RAS) command.

49. The method of claim 45 wherein the first memory device command is a refresh command.

50. The method of claim 45 wherein the first memory device command comprise a refresh command and a row access strobe (RAS) command.

51. The method of claim 45 wherein the first memory device command comprise a refresh command and a pre-charge command.

52. The method of claim 45 wherein the first memory device command is a mode register operation command.

53. The method of claim 45 wherein the first memory device command is a power mode command.

54. The method of claim 45, further comprising the steps of determining a first delay value based on the first index.

55. The method of claim of claim 54, further comprising:
providing a look-up table having a plurality of delay values and associated addresses, wherein each of the delay values is associated with one of the addresses, wherein the first index value represents one of the addresses in the look-up table, and wherein the step of determining the first delay value comprises selecting the delay value associated with the address of the first index.

56. The method of claim 34, wherein the first value is a first index value and the second value is a second index value.

57. The method of claim 56, further comprising the steps of
determining a first delay value based on the first index; and
determining a second delay value based on the second index.

58. The method of claim of claim 57, further comprising:
providing a look-up table having a plurality of delay values and associated addresses, wherein each of the delay values is associated with one of the addresses, wherein the first index represents a first addresses in the look-up table, wherein the step of determining the first delay value comprises selecting the delay value associated with first address, wherein the second index represents a second address in the look-up table, and wherein the step of determining the second delay value comprises selecting the delay value associated with second address.

59. The method of claim 58, wherein the first and second address are the same address.

60. The method of claim 59, wherein the first and second addresses are different addresses.

61. The method of claim 58, wherein the step of providing a look-up table comprises the steps of providing a first look-up table and a second look-up table, and wherein the first address is associated with the first look-up table and the second address is associated with the second look-up table.

62. The method of claim 57, wherein the first delay value determines, at least in part, a first performance time at which the first device command is to be performed, and wherein the second delay value determines, at least in part, a second performance time at which the second device command is to be performed.

63. The method of claim 34 wherein the first device command is sent to a first memory device at a first issuance time, and the second device command is sent to a second memory device at a second issuance time, the first issuance time being different from the second issuance time, wherein the first device command is performed at the first memory device while the second device command is performed at the second memory device.

64. A controller for scheduling commands comprising:
a driver for issuing commands and associated non-zero delay values to at least one device coupled to the controller, wherein a first delay value is associated with a first performance time at which a first command of the commands is to be performed by the device.

65. The controller of claim 64, wherein the driver comprises:
a first driver for issuing commands to the device and a second driver for issuing delay values to the device.

66. The controller of claim 64 wherein the controller is a memory controller.

67. The controller of claim 66 wherein the device is a memory device.

68. The controller of claim 64 wherein the driver issues the first command with a first delay value for performance of the first command at the first performance time and a second command with a second delay value for performance of the second command at a second performance time.

69. The controller of claim 64 wherein the controller determines performance constraints of the device to determine the first performance time and the second performance time.

70. The controller of claim 69 wherein the performance constraints are dependent upon a physical location of the device relative to the controller.

71. The controller of claim 69 wherein the performance constraints are dependent upon a propagation delay affecting reception of the first command at the device.

72. The controller of claim 69 wherein the performance constraints are dependent upon a propagation delay affecting reception of the data from the device.

73. The controller of claim 69 wherein the performance constraints are dependent upon a state of the device.

74. The controller of claim 69 wherein the performance constraints are dependent upon an operational speed limitation of the device.

75. The controller of claim 69 wherein the performance constraints are dependent upon a difference in timing granularity between an internal bus of the device and an external bus coupling the device to the controller.

76. The controller of claim 64 wherein the controller issues the first command at a first issuance time.

77. The controller of claim 76 wherein a delay between the first issuance time and the first performance time is determined by the first delay value and an additional value.

78. The controller of claim 76 wherein a delay between the first issuance time and a first decoding time at which the first command is decoded is determined by the first delay value and an additional delay value.

79. A device comprising:
a receiver for receiving a first device command, a first value associated with the first device command, wherein a first performance time is associated with the first value;
means for performing the first device command at the first performance time; and
control circuitry for controlling the means to cause the means to perform the first device command at the first performance time.

80. The device of claim 79 wherein the receiver is also for receiving a second device command and a second value associated with the second device command.

81. The device of claim 80 wherein a second performance time is associated with the second value.

82. The device of claim 81 wherein the means is also for performing the second device command at the second performance time.

83. The device of claim 80 wherein the second value is different from the first value.

84. The device of claim 80 wherein the second value is a delay value.

85. The device of claim 80 wherein the second value is an index value.

86. The device of claim 79 wherein the first value is a first delay value.

87. The device of claim 79 wherein the first value is a first index value.

88. The device of claim 79, wherein the first device command is a first memory device command, and the second device command is a second memory device command.

89. The device of claim 88, wherein the receiver comprises:
a first receiver for receiving the first device command; and
a second receiver for receiving the second device command.

90. The device of claim 89, wherein the first receiver is also for receiving the first index and the second receiver is also for receiving the second index.

91. The device of claim 89, wherein the first and second receivers are configured to receive the first and second device commands and the first and second indices from a controller.

92. The device of claim 91, wherein the controller is a memory controller.

93. The device of claim 88 wherein the first memory device command is a precharge command.

94. The device of claim 88 wherein the first memory device command is a row access strobe (RAS) command.

95. The device of claim 88 wherein the first memory device command is a refresh command.

96. The device of claim 88 wherein the first memory device command comprise a refresh command and a row access strobe (RAS) command.

97. The device of claim 88 wherein the first memory device command comprise a refresh command and a pre-charge command.

98. The device of claim 88 wherein the first memory device command is a mode register operation command.

99. The device of claim 88 wherein the first memory device command is a power mode command.

100. The device of claim 79 wherein the receiver first receives the first command and the first delay value, then later receives the second command and the second delay value, wherein the device performs the second command before performing the first command.

101. A system comprising
a first device configured to issue commands and values, wherein each of the values is associated with a respective one of the commands; and
a second device configured to receive the commands and the associated values; the second device further configured to execute each command at a time determined at least in part by the value associated with the command,
wherein the first device is further configured to dynamically determine the value associated with at least one of the commands.

102. The system of claim 1, wherein the first device is a memory controller and the second device is a memory device.

103. The system of claim 1, wherein each value is a delay value.

104. The system of claim 1, wherein each value is an index value which is representative of a delay value.

105. A system comprising:
a first device comprising
means for issuing commands; and
means for issuing values, wherein each of the values is associated with a respective one of the commands; and
a second device comprising:
means for receiving commands;
means for receiving the associated values; and
means for performing each of said commands at a time determined at least in part by the associated value.

106. The system of claim 1, wherein each value is a delay value.

107. The system of claim 1, wherein each value is an index value which is representative of a delay value.
